(19) United States
(12) Patent Application Publication
(10) Pub. No.: US 2025/0078589 A1
(43) Pub. Date: Mar. 6, 2025

(54) AUTOMATIC DETECTION SYSTEM FOR INSTALLATION OF INTELLIGENT DOOR LOCK

(71) Applicants: Li ZHENG, Kowloon (HK); PIN GENIE LIMITED, Kowloon (HK)

(72) Inventor: Li ZHENG, Kowloon (HK)

(73) Assignees: Li ZHENG, Kowloon (HK); PIN GENIE LIMITED, Kowloon (HK)

(21) Appl. No.: 18/462,205

(22) Filed: Sep. 6, 2023

(51) Int. Cl. G07C 9/00; G01C 19/00

(52) U.S. Cl. CPC G07C 9/00174; G01C 19/00; G07C 2209/62

(57) ABSTRACT

The present invention relates to the field of installation detection, in particular to an automatic detection system for installation of an intelligent door lock. The system comprises an intelligent lock unit and a feedback terminal; the intelligent lock unit is used for detecting the installation state of a locking structure; the intelligent lock unit comprises the locking structure, a lock control module, an intelligent controller and a locking representation detection module; the lock control module is used for controlling a switch lock state of the locking structure; the lock control module and the intelligent controller are electrically connected with the locking representation detection module respectively; the locking representation detection module is used for detecting the performance characteristic data of the locking structure during installation; the intelligent controller presets standard state data, compares the performance characteristic data with the standard state data, and determines whether the installation state of the locking structure is locking according to a comparison result; the feedback terminal is connected with the intelligent lock unit; and the feedback terminal is used for feeding back the detection result of the installation state detected by the intelligent lock unit. The present invention can accurately and quickly judge whether locking occurs during installation of the door lock.

### TECHNICAL FIELD

The present invention relates to the field of installation detection, in particular to an automatic detection system for installation of an intelligent door lock.

### BACKGROUND

Compared with a traditional mechanical lock, the intelligent door lock is an improved lock which is more intelligent and simple in the aspects of user safety, identification and management. Users can install the intelligent door lock by themselves, and can also contact professional installers for installing the door lock. When the door lock is installed, there may be a locking problem. At present, it is judged whether the intelligent door lock is locked through manual operation of the door lock and feeling or experience. The judgment is not high in accuracy and consumes time, and it is impossible to quickly and accurately judge whether the intelligent door lock is installed to a best working state.

### SUMMARY OF THE INVENTION

The purpose of the present invention is to propose an automatic detection system for installation of an intelligent door lock, which can accurately and quickly judge whether locking occurs during installation of the door lock with respect to the problems in the background.

In one aspect, the present invention proposes a first automatic detection system for installation of an intelligent door lock. The detection system comprises an intelligent lock unit and a feedback terminal.

The intelligent lock unit is used for detecting the installation state of a locking structure; the intelligent lock unit comprises the locking structure, a lock control module, an intelligent controller and a locking representation detection module; the lock control module is used for controlling a switch lock state of the locking structure; the lock control module and the intelligent controller are electrically connected with the locking representation detection module respectively; the locking representation detection module is used for detecting the performance characteristic data of the locking structure during installation. The intelligent controller presets standard state data, compares the performance characteristic data with the standard state data, and determines whether the installation state of the locking structure is locking according to a comparison result.

The feedback terminal is connected with the intelligent lock unit; and the feedback terminal is used for feeding back the detection result of the installation state detected by the intelligent lock unit.

Preferably, the locking representation detection module comprises at least one of a sensing module, a current signal collection module and a transmission data collection module; the sensing module correspondingly determines the installation position and/or direction of the locking structure by detecting an own spatial position and/or direction; the current signal collection module is used for collecting current magnitude information; and the transmission data collection module comprises an audio collection module and/or a video collection module for collecting switch lock sound and/or video.

The standard state data comprise correct spatial position and/or direction data for comparison with detection results of the sensing module, normal current data for comparison with information collected by the current signal collection module, and normal sound and/or video data for comparison with the switch lock sound and/or video collected by the transmission data collection module; when at least one of the following data inconsistencies occurs, the installation state of the locking structure is determined as locking:
a. the detected spatial position and/or direction are inconsistent with the corresponding correct spatial position and/or direction data;
b. the collected current magnitude information is inconsistent with the normal current data;
c. the collected switch lock sound and/or video is inconsistent with the corresponding normal sound and/or video data.

Preferably, the locking structure is a lock tongue; the sensing module is a gyroscope sensor; when the transmission data collection module comprises the audio collection module, the audio collection module is a microphone sensor or pickup; and the feedback terminal is a buzzer.

Preferably, the intelligent controller is in communication connection with a feedback module for feeding back the performance characteristic data of the locking structure during installation; the feedback module is in communication connection with a wireless receiving and transmitting module; and the wireless receiving and transmitting module feeds back information to a user APP platform.

In another aspect, the present invention proposes a second automatic detection system for installation of an intelligent door lock. The detection system comprises an intelligent lock unit and a feedback terminal.

The intelligent lock unit is used for detecting the installation state of a locking structure. The intelligent lock unit comprises the locking structure, a lock control module, an intelligent controller and a locking representation detection module, wherein the lock control module is used for controlling a switch lock state of the locking structure; the lock control module and the intelligent controller are electrically connected with the locking representation detection module respectively; the locking representation detection module is used for detecting the performance characteristic data of the locking structure during installation; the locking representation detection module comprises a current signal collection module and a transmission data collection module; the current signal collection module is used for collecting current magnitude information; the transmission data collection module comprises an audio collection module and/or a video collection module for collecting switch lock sound and/or video; the intelligent controller presets normal current data for comparison with information collected by the current signal collection module, and normal sound and/or video data for comparison with the switch lock sound and/or video collected by the transmission data collection module and determines whether the installation state of the locking structure is locking according to a comparison result.

The feedback terminal is connected with the intelligent lock unit; and the feedback terminal is used for feeding back the detection result of the installation state detected by the intelligent lock unit.

Preferably, when the collected current magnitude information is inconsistent with the normal current data, the installation state of the locking structure is directly determined as locking;
when the collected current magnitude information is consistent with the normal current data, the collected switch lock sound and/or video and the normal sound and/or video data are compared and determined whether consistent, and if not, the installation state of the locking structure is determined as locking.

Preferably, the locking structure is a lock tongue; when the transmission data collection module comprises the audio collection module, the audio collection module is a microphone sensor or pickup; and the feedback terminal is a buzzer.

The intelligent controller is in communication connection with a feedback module for feeding back the performance characteristic data of the locking structure during installation; the feedback module is in communication connection with a wireless receiving and transmitting module; and the wireless receiving and transmitting module feeds back information to a user APP platform.

In another aspect, the present invention proposes a third automatic detection system for installation of an intelligent door lock. The detection system comprises an intelligent lock unit and a feedback terminal.

The intelligent lock unit is used for detecting the installation state of a locking structure. The intelligent lock unit comprises the locking structure, a lock control module, an intelligent controller and a locking representation detection module, wherein the lock control module is used for controlling a switch lock state of the locking structure; the lock control module and the intelligent controller are electrically connected with the locking representation detection module respectively; the locking representation detection module comprises a sensing module, a current signal collection module and a transmission data collection module; the sensing module correspondingly determines the installation position and/or direction of the locking structure by detecting an own spatial position and/or direction; the current signal collection module is used for collecting current magnitude information; the transmission data collection module comprises an audio collection module and/or a video collection module for collecting switch lock sound and/or video; The intelligent controller presets correct spatial position and/or direction data for comparison with detection results of the sensing module, normal current data for comparison with information collected by the current signal collection module, and normal sound and/or video data for comparison with the switch lock sound and/or video collected by the transmission data collection module and determines whether the installation state of the locking structure is locking according to a comparison result.

The feedback terminal is connected with the intelligent lock unit; and the feedback terminal is used for feeding back the detection result of the installation state detected by the intelligent lock unit.

Preferably, when the detected spatial position and/or direction is inconsistent with the correct spatial position and/or direction data, the installation state of the locking structure is directly determined as locking;
when the detected spatial position and/or direction is consistent with the correct spatial position and/or direction data, the collected current magnitude information and the normal current data are compared and determined whether consistent; if not, the installation state of the locking structure is determined as locking; if yes, the collected switch lock sound and/or video and the normal sound and/or video data are compared and determined whether consistent; if not, the installation state of the locking structure is determined as locking.

Preferably, the locking structure is a lock tongue; the sensing module is a gyroscope sensor; when the transmission data collection module comprises the audio collection module, the audio collection module is a microphone sensor or pickup; and the feedback terminal is a buzzer.

The intelligent controller is in communication connection with a feedback module for feeding back the performance characteristic data of the locking structure during installation; the feedback module is in communication connection with a wireless receiving and transmitting module; and the wireless receiving and transmitting module feeds back information to a user APP platform.

Compared with the prior art, the present invention has the following beneficial technical effects:

The present invention can accurately and quickly judge whether locking occurs during installation of the door lock. The locking representation detection module can detect the performance characteristic data of the locking structure during installation, compare the detected performance characteristic data with the standard state data, and determine whether the installation state of the locking structure is locking according to the comparison result, thereby realizing automatic detection and determination, high determination efficiency, high accuracy, strong credibility and good timeliness. When locking appears, feedback alarm is directly made through the feedback terminal, so that the installation personnel can quickly know the locking situation and then adjust parts of the intelligent door lock for reinstallation until the intelligent door lock is installed in place.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a structural block diagram of a system in an embodiment of the present invention;

FIG. 2 is a flow chart of detection for a locking state in an embodiment of the present invention.

### DETAILED DESCRIPTION OF THE EMBODIMENTS

### Embodiment 1

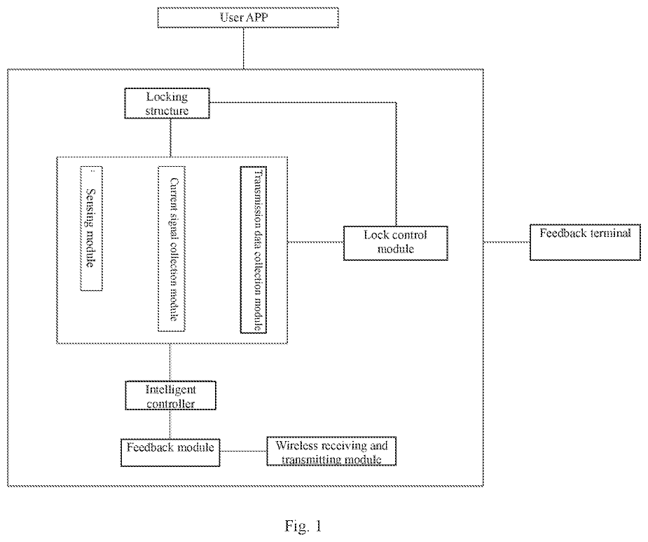

As shown in FIG. 1, the present embodiment proposes an automatic detection system for installation of an intelligent door lock. The detection system comprises an intelligent lock unit, a feedback terminal, a feedback module and a wireless receiving and transmitting module.

The intelligent lock unit is used for detecting the installation state of a locking structure; the intelligent lock unit comprises the locking structure, a lock control module, an intelligent controller and a locking representation detection module; the locking structure is a lock tongue; the lock control module is used for controlling a switch lock state of the locking structure; the lock control module and the intelligent controller are electrically connected with the locking representation detection module respectively; the locking representation detection module is used for detecting the performance characteristic data of the locking structure during installation. The intelligent controller presets standard state data, compares the performance characteristic data with the standard state data, and determines whether the installation state of the locking structure is locking according to a comparison result.

The feedback terminal is connected with the intelligent lock unit; and the feedback terminal is used for feeding back the detection result of the installation state detected by the intelligent lock unit. The feedback terminal is a buzzer which can beep to give an alarm when locking appears, which is convenient for the installation personnel to find the locking situation in time and then adjust the installation measure and the installation position of the intelligent door lock until the intelligent door lock is installed in a correct position without locking.

The intelligent controller is in communication connection with the feedback module. The feedback module is in communication connection with the wireless receiving and transmitting module. The feedback module is used for feeding back the performance characteristic data of the locking structure during installation, and feeding back information to a user APP platform through the wireless receiving and transmitting module. The wireless receiving and transmitting module comprises a wireless receiving module and a wireless transmitting module. The wireless receiving module can receive the performance characteristic data fed back by the feedback module, and the wireless transmitting module can transmit the performance characteristic data to the APP platform wirelessly. Users can know whether the received data is matched with the standard state data on the APP platform, so as to know whether locking occurs on the locking structure. The APP platform can timely know the locking situation of the locking structure of a customer, so as to conveniently prompt the users for later maintenance through the APP.

The locking representation detection module comprises at least one of a sensing module, a current signal collection module and a transmission data collection module; the sensing module is a gyroscope sensor; and the sensing module correspondingly determines the installation position and/or direction of the locking structure, i.e., the position and/or orientation of the lock tongue, by detecting an own spatial position and/or direction, which can accurately judge whether the lock tongue is installed in place as required, whether the direction is correct, whether the position deviates and whether the lock tongue is horizontally installed during installation. The current signal collection module is used for collecting current magnitude information, and according to the fluctuation of the current and the time of opening and closing the lock, the lock body can be accurately judged whether installed in place and whether there is a locking phenomenon. The transmission data collection module comprises an audio collection module and/or a video collection module for collecting switch lock sound and/or video. The lock body can be judged whether installed in place and whether there is a locking phenomenon by analyzing whether switch lock sound and video pictures are normal. The audio collection module is a microphone sensor or pickup. The microphone sensor is a microphone. The audio collection module can convert sound signals to electric signals.

The standard state data comprise correct spatial position and/or direction data for comparison with detection results of the sensing module, normal current data for comparison with information collected by the current signal collection module, and normal sound and/or video data for comparison with the switch lock sound and/or video collected by the transmission data collection module; when at least one of the following data inconsistencies occurs, the installation state of the locking structure is determined as locking:
a. the detected spatial position and/or direction are inconsistent with the corresponding correct spatial position and/or direction data;
b. the collected current magnitude information is inconsistent with the normal current data;
c. the collected switch lock sound and/or video is inconsistent with the corresponding normal sound and/or video data.

The above specific data comparison and locking determination according to the coverage range of the locking representation detection module can be specifically divided into the following seven situations:

\textcircled{1} When the locking representation detection module only comprises the sensing module, if the spatial position and/or direction detected by the sensing module is inconsistent with the corresponding correct spatial position and/or direction data, i.e., the detected spatial position is inconsistent with the correct spatial position or the detected direction is inconsistent with the correct direction or the spatial position and direction are inconsistent, then the installation state of the locking structure is determined as locking, the buzzer gives an alarm and the APP prompts the locking; if the spatial position and/or direction detected by the sensing module is consistent with the corresponding correct spatial position and/or direction data, i.e., the detected spatial position is consistent with the correct spatial position or the detected direction is consistent with the correct direction or the spatial position and direction are consistent, then the installation state of the locking structure is determined as not locking, the buzzer does not give an alarm and the APP does not prompt locking.

\textcircled{2} When the locking representation detection module only comprises the current signal collection module, if the current magnitude information collected by the current signal collection module is inconsistent with the normal current data, then the installation state of the locking structure is determined as locking, the buzzer gives an alarm and the APP prompts the locking; if the current magnitude information collected by the current signal collection module is consistent with the normal current data, then the installation state of the locking structure is determined as not locking, the buzzer does not give an alarm and the APP does not prompt locking.

\textcircled{3} When the locking representation detection module only comprises the transmission data collection module, if the switch lock sound and/or video collected by the transmission data collection module is inconsistent with the corresponding normal sound and/or video data, i.e., the collected sound is inconsistent with the normal sound or the collected video is inconsistent with the normal video or the sound and the video are inconsistent, then the installation state of the locking structure is determined as locking, the buzzer gives an alarm and the APP prompts the locking; if the switch lock sound and/or video collected by the transmission data collection module is consistent with the corresponding normal sound and/or video data, then the installation state of the locking structure is determined as not locking, the buzzer does not give an alarm and the APP does not prompt locking.

\textcircled{4} When the locking representation detection module comprises the sensing module and the current signal collection module, if the spatial position and/or direction detected by the sensing module is inconsistent with the corresponding correct spatial position and/or direction data or the current magnitude information collected by the current signal collection module is inconsistent with the normal current data or the spatial position and/or direction and the current magnitude information are inconsistent, then the installation state of the locking structure is determined as locking, the buzzer gives an alarm and the APP prompts the locking; if the spatial position and/or direction detected by the sensing module is consistent with the corresponding correct spatial position and/or direction data and the current magnitude information collected by the current signal collection module is consistent with the normal current data, then the installation state of the locking structure is determined as not locking, the buzzer does not give an alarm and the APP does not prompt locking.

\textcircled{5} When the locking representation detection module comprises the current signal collection module and the transmission data collection module, if the current magnitude information collected by the current signal collection module is inconsistent with the normal current data or the switch lock sound and/or video collected by the transmission data collection module is inconsistent with the corresponding normal sound and/or video data or the current magnitude information and the switch lock sound and/or video are inconsistent, then the installation state of the locking structure is determined as locking, the buzzer gives an alarm and the APP prompts the locking; if the current magnitude information collected by the current signal collection module is consistent with the normal current data and the switch lock sound and/or video collected by the transmission data collection module is consistent with the corresponding normal sound and/or video data, then the installation state of the locking structure is determined as not locking, the buzzer does not give an alarm and the APP does not prompt locking.

\textcircled{6} When the locking representation detection module comprises the sensing module and the transmission data collection module, if the spatial position and/or direction detected by the sensing module is inconsistent with the corresponding correct spatial position and/or direction data or the switch lock sound and/or video collected by the transmission data collection module is inconsistent with the corresponding normal sound and/or video data or the spatial position and/or direction and the switch lock sound and/or video are inconsistent, then the installation state of the locking structure is determined as locking, the buzzer gives an alarm and the APP prompts the locking; if the spatial position and/or direction detected by the sensing module is consistent with the corresponding correct spatial position and/or direction data and the switch lock sound and/or video collected by the transmission data collection module is consistent with the corresponding normal sound and/or video data, then the installation state of the locking structure is determined as not locking, the buzzer does not give an alarm and the APP does not prompt locking.

\textcircled{7} When the locking representation detection module comprises the sensing module, the current signal collection module and the transmission data collection module, if the spatial position and/or direction detected by the sensing module is inconsistent with the corresponding correct spatial position and/or direction data or the current magnitude information collected by the current signal collection module is inconsistent with the normal current data or the switch lock sound and/or video collected by the transmission data collection module is inconsistent with the corresponding normal sound and/or video data or any two are inconsistent or the three are inconsistent, then the installation state of the locking structure is determined as locking, the buzzer gives an alarm and the APP prompts the locking; if the spatial position and/or direction detected by the sensing module is consistent with the corresponding correct spatial position and/or direction data, the current magnitude information collected by the current signal collection module is consistent with the normal current data and the switch lock sound and/or video collected by the transmission data collection module is consistent with the corresponding normal sound and/or video data, i.e., the three are consistent, then the installation state of the locking structure is determined as not locking, the buzzer does not give an alarm and the APP does not prompt locking.

The present embodiment can accurately and quickly judge whether locking occurs during installation of the door lock. The locking representation detection module comprises at least one of the sensing module, the current signal collection module and the transmission data collection module. As long as one detection datum is inconsistent with the standard state data, it indicates that the locking structure is locked. Multiple types of detection and determination processes can determine the locking situation more accurately and strictly. When locking appears, feedback alarm is directly made through the feedback terminal, so that the installation personnel can quickly know the locking situation and then adjust parts of the intelligent door lock for reinstallation until the intelligent door lock is installed in place.

### Embodiment 2

The present embodiment proposes an automatic detection system for installation of an intelligent door lock. The differences between the present embodiment and embodiment 1 are that: the locking representation detection module comprises a current signal collection module and a transmission data collection module; the current signal collection module is used for collecting current magnitude information, and the transmission data collection module comprises an audio collection module and/or a video collection module for collecting switch lock sound and/or video; the intelligent controller presets normal current data for comparison with information collected by the current signal collection module, and normal sound and/or video data for comparison with the switch lock sound and/or video collected by the transmission data collection module and determines whether the installation state of the locking structure is locking according to a comparison result.

When the collected current magnitude information is inconsistent with the normal current data, the installation state of the locking structure is directly determined as locking; when the collected current magnitude information is consistent with the normal current data, the collected switch lock sound and/or video and the normal sound and/or video data are compared and determined whether consistent, and if not, the installation state of the locking structure is determined as locking.

The present embodiment uses the current signal collection module and the transmission data collection module for detecting the data related to the locking. Firstly, the current signal collection module is used for collecting the current magnitude information. When the collected current magnitude information is inconsistent with the normal current data, locking is determined, and the transmission data collection module is not invoked for collecting switch lock sound and/or video, thereby saving electric energy. When the current magnitude information collected by the current signal collection module is consistent with the normal current data, the transmission data collection module is invoked for collecting switch lock sound and/or video and then comparing and determining the collected switch lock sound and/or video with the normal sound and/or video data are consistent; if not, locking is determined, thereby realizing dual detection so that the is determining process is more strict.

### Embodiment 3

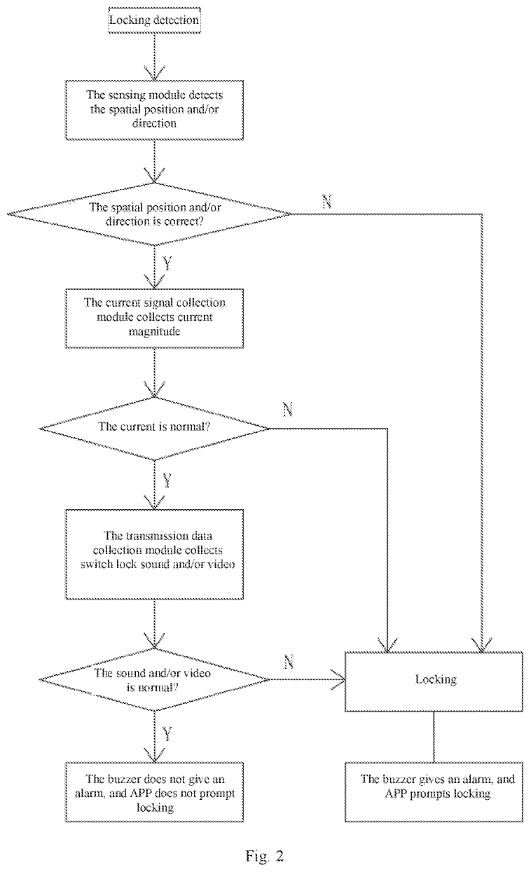

As shown in FIG. 1 and FIG. 2, the present embodiment proposes an automatic detection system for installation of an intelligent door lock. The differences of the present embodiment from embodiment 1 and embodiment 2 are that: the intelligent lock unit is used for detecting the installation state of a locking structure. The intelligent lock unit comprises the locking structure, a lock control module, an intelligent controller and a locking representation detection module, wherein the lock control module is used for controlling a switch lock state of the locking structure; the lock control module and the intelligent controller are electrically connected with the locking representation detection module respectively; the locking representation detection module comprises a sensing module, a current signal collection module and an audio collection module; the sensing module correspondingly determines the installation position and/or direction of the locking structure by detecting an own spatial position and/or direction; the current signal collection module is used for collecting current magnitude information; the transmission data collection module comprises an audio collection module and/or a video collection module for collecting switch lock sound and/or video; the intelligent controller presets correct spatial position and/or direction data for comparison with detection results of the sensing module, normal current data for comparison with information collected by the current signal collection module, and normal sound and/or video data for comparison with the switch lock sound and/or video collected by the transmission data collection module and determines whether the installation state of the locking structure is locking according to a comparison result:

When the detected spatial position and/or direction is inconsistent with the correct spatial position and/or direction data, the installation state of the locking structure is directly determined as locking.

When the detected spatial position and/or direction is consistent with the correct spatial position and/or direction data, the collected current magnitude information and the normal current data are compared and determined whether consistent; if not, the installation state of the locking structure is determined as locking; if yes, the collected switch lock sound and/or video and the normal sound and/or video data are compared and determined whether consistent; if not, the installation state of the locking structure is determined as locking.

The present embodiment uses the sensing module, the current signal collection module and the transmission data collection module for detecting the data related to the locking successively. Firstly, the sensing module is used for detection. When the detected spatial position and/or direction is inconsistent with the correct spatial position and/or direction data, the locking is directly determined and the current signal collection module and the transmission data collection module are not invoked, thereby saving electric energy. When the spatial position and/or direction detected by the sensing module is consistent with the correct spatial position and/or direction data, the current signal collection module is invoked for detecting the current magnitude information data; then, the collected current magnitude information and the normal current data are compared and determined whether consistent; if not, the locking is determined and the transmission data collection module is not invoked; if yes, the transmission data collection module is invoked for collecting switch lock sound and/or video and then comparing the switch lock sound and/or video with the normal sound and/or video data; if inconsistent, locking is determined. Only when the three kinds of detection data are consistent with the normal data, the locking structure is determined as not locking, thereby realizing triple progressive detection. The process of determining not locking is more strict to prevent misjudgment so that the credibility of judgment is strong.

The embodiments of the present invention are described in detail above in combination with the drawings. However, the present invention is not limited to this. Various changes can be made within the scope of knowledge of those skilled in the art on the premise of not deviating from the purpose of the present invention.

What is claimed is:

1. An automatic detection system for installation of an intelligent door lock, comprising:
an intelligent lock unit, used for detecting the installation state of a locking structure, comprising the locking structure, a lock control module, an intelligent controller and a locking representation detection module, wherein the lock control module is used for controlling a switch lock state of the locking structure; the lock control module and the intelligent controller are electrically connected with the locking representation detection module respectively; the locking representation detection module is used for detecting the performance characteristic data of the locking structure during installation; the intelligent controller presets standard state data, compares the performance characteristic data with the standard state data, and determines whether the installation state of the locking structure is locking according to a comparison result;
a feedback terminal, connected with the intelligent lock unit for feeding back the detection result of the installation state detected by the intelligent lock unit.

2. The automatic detection system for installation of the intelligent door lock according to claim 1, wherein the locking representation detection module comprises at least one of a sensing module, a current signal collection module and a transmission data collection module; the sensing module correspondingly determines the installation position and/or direction of the locking structure by detecting an own spatial position and/or direction; the current signal collection module is used for collecting current magnitude information; and the transmission data collection module comprises an audio collection module and/or a video collection module for collecting switch lock sound and/or video;
the standard state data comprise correct spatial position and/or direction data for comparison with detection results of the sensing module, normal current data for comparison with information collected by the current signal collection module, and normal sound and/or video data for comparison with the switch lock sound and/or video collected by the transmission data collection module; when at least one of the following data inconsistencies occurs, the installation state of the locking structure is determined as locking:
a. the detected spatial position and/or direction are inconsistent with the corresponding correct spatial position and/or direction data;
b. the collected current magnitude information is inconsistent with the normal current data;
c. the collected switch lock sound and/or video is inconsistent with the corresponding normal sound and/or video data.

3. The automatic detection system for installation of the intelligent door lock according to claim 2, wherein the locking structure is a lock tongue; the sensing module is a gyroscope sensor; when the transmission data collection module comprises the audio collection module, the audio collection module is a microphone sensor or pickup; and the feedback terminal is a buzzer.

4. The automatic detection system for installation of the intelligent door lock according to claim 1, wherein the intelligent controller is in communication connection with a feedback module for feeding back the performance characteristic data of the locking structure during installation; the feedback module is in communication connection with a wireless receiving and transmitting module; and the wireless receiving and transmitting module feeds back information to a user APP platform.

5. An automatic detection system for installation of an intelligent door lock, comprising:
an intelligent lock unit, used for detecting the installation state of a locking structure, comprising the locking structure, a lock control module, an intelligent controller and a locking representation detection module, wherein the lock control module is used for controlling a switch lock state of the locking structure; the lock control module and the intelligent controller are electrically connected with the locking representation detection module respectively; the locking representation detection module is used for detecting the performance characteristic data of the locking structure during installation; the locking representation detection module comprises a current signal collection module and a transmission data collection module; the current signal collection module is used for collecting current magnitude information; the transmission data collection module comprises an audio collection module and/or a video collection module for collecting switch lock sound and/or video; the intelligent controller presets normal current data for comparison with information collected by the current signal collection module, and normal sound and/or video data for comparison with the switch lock sound and/or video collected by the transmission data collection module and determines whether the installation state of the locking structure is locking according to a comparison result;
a feedback terminal, connected with the intelligent lock unit for feeding back the detection result of the installation state detected by the intelligent lock unit.

6. The automatic detection system for installation of the intelligent door lock according to claim 5, wherein
when the collected current magnitude information is inconsistent with the normal current data, the installation state of the locking structure is directly determined as locking;
when the collected current magnitude information is consistent with the normal current data, the collected switch lock sound and/or video and the normal sound and/or video data are compared and determined whether consistent, and if not, the installation state of the locking structure is determined as locking.

7. The automatic detection system for installation of the intelligent door lock according to claim 5, wherein the locking structure is a lock tongue; when the transmission data collection module comprises the audio collection module, the audio collection module is a microphone sensor or pickup; and the feedback terminal is a buzzer;
the intelligent controller is in communication connection with a feedback module for feeding back the performance characteristic data of the locking structure during installation; the feedback module is in communication connection with a wireless receiving and transmitting module; and the wireless receiving and transmitting module feeds back information to a user APP platform.

8. An automatic detection system for installation of an intelligent door lock, comprising:
an intelligent lock unit, used for detecting the installation state of a locking structure, comprising the locking structure, a lock control module, an intelligent controller and a locking representation detection module, wherein the lock control module is used for controlling a switch lock state of the locking structure; the lock control module and the intelligent controller are electrically connected with the locking representation detection module respectively; the locking representation detection module comprises a sensing module, a current signal collection module and a transmission data collection module; the sensing module correspondingly determines the installation position and/or direction of the locking structure by detecting an own spatial position and/or direction; the current signal collection module is used for collecting current magnitude information; the transmission data collection module comprises an audio collection module and/or a video collection module for collecting switch lock sound and/or video; the intelligent controller presets correct spatial position and/or direction data for comparison with detection results of the sensing module, normal current data for comparison with information collected by the current signal collection module, and normal sound and/or video data for comparison with the switch lock sound and/or video collected by the transmission data collection module and determines whether the installation state of the locking structure is locking according to a comparison result;
a feedback terminal, connected with the intelligent lock unit for feeding back the detection result of the installation state detected by the intelligent lock unit.

9. The automatic detection system for installation of the intelligent door lock according to claim 8, wherein
when the detected spatial position and/or direction is inconsistent with the correct spatial position and/or direction data, the installation state of the locking structure is directly determined as locking;
when the detected spatial position and/or direction is consistent with the correct spatial position and/or direction data, the collected current magnitude information and the normal current data are compared and determined whether consistent; if not, the installation state of the locking structure is determined as locking; if yes, the collected switch lock sound and/or video and the normal sound and/or video data are compared and determined whether consistent; if not, the installation state of the locking structure is determined as locking.

10. The automatic detection system for installation of the intelligent door lock according to claim 8, wherein the locking structure is a lock tongue; the sensing module is a gyroscope sensor; when the transmission data collection module comprises the audio collection module, the audio collection module is a microphone sensor or pickup; and the feedback terminal is a buzzer;
the intelligent controller is in communication connection with a feedback module for feeding back the performance characteristic data of the locking structure during installation; the feedback module is in communication connection with a wireless receiving and transmitting module; and the wireless receiving and transmitting module feeds back information to a user APP platform.

11. The automatic detection system for installation of the intelligent door lock according to claim 2, wherein the intelligent controller is in communication connection with a feedback module for feeding back the performance characteristic data of the locking structure during installation; the feedback module is in communication connection with a wireless receiving and transmitting module; and the wireless receiving and transmitting module feeds back information to a user APP platform.

12. The automatic detection system for installation of the intelligent door lock according to claim 3, wherein the intelligent controller is in communication connection with a feedback module for feeding back the performance characteristic data of the locking structure during installation; the feedback module is in communication connection with a wireless receiving and transmitting module; and the wireless receiving and transmitting module feeds back information to a user APP platform.

13. The automatic detection system for installation of the intelligent door lock according to claim 6, wherein the locking structure is a lock tongue; when the transmission data collection module comprises the audio collection module, the audio collection module is a microphone sensor or pickup; and the feedback terminal is a buzzer;
the intelligent controller is in communication connection with a feedback module for feeding back the performance characteristic data of the locking structure during installation; the feedback module is in communication connection with a wireless receiving and transmitting module; and the wireless receiving and transmitting module feeds back information to a user APP platform.

14. The automatic detection system for installation of the intelligent door lock according to claim 9, wherein the locking structure is a lock tongue; the sensing module is a gyroscope sensor; when the transmission data collection module comprises the audio collection module, the audio collection module is a microphone sensor or pickup; and the feedback terminal is a buzzer;
the intelligent controller is in communication connection with a feedback module for feeding back the performance characteristic data of the locking structure during installation; the feedback module is in communication connection with a wireless receiving and transmitting module; and the wireless receiving and transmitting module feeds back information to a user APP platform.
